(19) United States
(12) Patent Application Publication
(10) Pub. No.: US 2016/0055567 A1
(43) Pub. Date: Feb. 25, 2016

(54) Online Interactive Database on Gift Choice Preferences of Recipients

(71) Applicant: Urfan N. Nadirov, Portland, ME (US)

(72) Inventor: Urfan N. Nadirov, Portland, ME (US)

(21) Appl. No.: 14/466,994

(22) Filed: Aug. 23, 2014

(51) Int. Cl. G06Q 30/06

(52) U.S. Cl. CPC G06Q 30/0631

(57) ABSTRACT

The Online Interactive Database on Gift Choice Preferences of Recipients aims to provide useful information on the gift choice preferences of specific group of people on a specific occasion to the people who're looking for a gift for somebody, to assist them on making final decision on a gift choice. The database contains generalized information on gift choice preferences of people according to the occasion, country of residence (in the USA+state), gender, age group, marital status, level of relationship, occupation, hobbies, attitude to expensive gift and an expensive gift perception, attitude to gift+flowers combination. Information for the database mostly generates by the website visitors: in order to get access to the database each visitor chooses a desired (assumed) gift for himself/herself on the same occasion from the person whom looks for a gill information on gift choice preferences of the recipients from the database displays as a graph of the gift categories. Visitors can choose any gift category to find out gift choice preferences of recipients within each category and subcategories.

### CROSS-REFERENCE TO RELATED APPLICATIONS

NOT APPLICABLE

### STATEMENT REGARDING FEDERALLY SPONSORED RESEARCH OR DEVELOPMENT

### NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF INVENTION

It's not easy task to buy a gift for somebody. Moreover, it is very time consuming. As usually people don't know which gift the recipients would prefer, even if he or she is a close one. Also, most of the time it's not appropriate to ask them about their opinion. So, people visit stores and websites, spend a lot of time looking for different gift options in order to make a final decision on their gift choice. Usually people make the gift choice decisions solely on their own judgment. Meanwhile, existing gift websites offer a lot of gift ideas and products. However, when somebody visits these websites, the same question rises again: what would be his or her (gift recipient's) attitude to the gifts he or she (website visitor) is considering to buy. Moreover, these sites are often specialized, their offers are limited and don't cover all the possible gift options.

Offered method allows people who are looking for a gift for somebody to visit the website, which will be created on the base of the principles described below, to get generalized information on gift choice preferences of specific group of people on specific occasion. It will make people more confident on their gift choice and allow them to save significant time to find the gifts statistically well accepted by the recipients.

### BRIEF SUMMARY OF THE INVENTION

The Online Interactive Database on Gift Choice Preferences of Recipients allows website visitors to get access to the Database in return of the provided information on their own gift preferences:
Visitor chooses occasion for a gift;
Visitor enters general information about a gift recipient;
Visitor enters general information about himself/herself;
Visitor chooses a desired gift (assumed) for himself/herself from the person he/she is seeking a gift for, using the provided Gift Catalog;
Visitor is granted access to the Database where displays generalized information on gift choice preferences of specific group of people on designated occasions from the designated people. Visitor can choose the criteria to get more specific or general information. The gift choice preferences of the recipients are displayed as the graphs of the Gift Categories. Visitors can choose any Gift Category and get information within each category, also supported with the graphs.

### BRIEF DESCRIPTION OF THE SEVERAL VIEWS OF THE DRAWING

FIG. 1 describes the occasions for a gift.

FIGS. 2A, 2B, 2C, 2D, 2E, 2F, 2G, 2H, 2I describes general information to characterize gift recipient.

FIGS. 3A, 3B, 3C, 3D, 3E, 3F, 3G describes general information to characterize website visitor.

FIG. 4 describes the gift choice options by the Gift Categories.

FIGS. 5A, 5B, 5C, 5D describes the gift choice options for the Apparel and accessories Category.

FIGS. 6A, 6B describes the gift choice options for the Footwear Category.

FIGS. 7A, 7B describes the gift choice options for the Bags and handbags Category.

FIGS. 8A, 8B, 8C describes the gift choice options for the Jewelry Category.

FIG. 9 describes the gift choice options for the Souvenirs Category.

FIG. 10 describes the gift choice options for the Electronics Category.

FIG. 11 describes the gift choice options for the Beauty and health Category.

FIG. 12 describes the gift choice options for the Gift cards Category.

FIG. 13 describes the gift choice options for the Books Category.

FIG. 14 describes the gift choice options for the Candies and chocolates Category.

FIG. 15 describes the gift choice options for the Toys Category.

FIG. 16 describes the gift choice options for the Handmade gifts by kids Category.

FIG. 17 describes the gift choice options for the Sport gear and accessories Category.

FIGS. 18A, 18B describes the gift choice options for the Outdoor gear and accessories Category.

FIG. 19 describes the gift choice options for the Hunting and fishing Category.

FIGS. 20A, 20B describes the gift choice options for the Home goods Category.

FIG. 21 describes the gift choice options for the Car accessories Category.

FIG. 22 describes information about gift recipient and occasion. This information appears on the screen when access to database is granted.

FIG. 23 describes attitude of the gift recipients to an expensive gift.

FIG. 24 describes perception of an expensive gift by recipients.

FIG. 25 describes attitude of the gift recipients to the Gift or Gift+Flowers combination.

FIG. 26 describes the gift choice preferences of recipients by the Gift Categories.

FIG. 27 describes the gift choice preferences of recipients within the Footwear Category.

FIG. 28 describes the gift choice preferences of recipients within the Shoes option.

FIG. 29 describes the steps to find out the Gift choice preferences of recipients within the Footwear Category.

### DETAILED DESCRIPTION OF THE INVENTION

The Online Interactive Database on Gift Choice Preferences of Recipients contains generalized information on gift choice preferences of people according to relationship and occasions, by the county of residence (states in the USA), gender, month of birth, age group, marital status, occupation, level of relationship, and hobbies. The Database also contains information on opinion of people about expensive gifts, expensive gift perception, gift or gift+flowers combination. Information displays on the screens as the graphs, meanwhile percentage and numbers also may or may not to appear.

In general, information for the Database is generated by visitors of the website. Meanwhile, paper surveys also can be conducted to gather information as initial inputs to the Database, as well as for specific groups of people (for example kids 5-12 years of age).

When people visit the website instruction and/or demo to briefly explain how to use Online Interactive Database on Gift Choice Preferences of Recipients appears on the home page. After getting familiar with the instruction visitors can take the necessary steps to get access to Database.

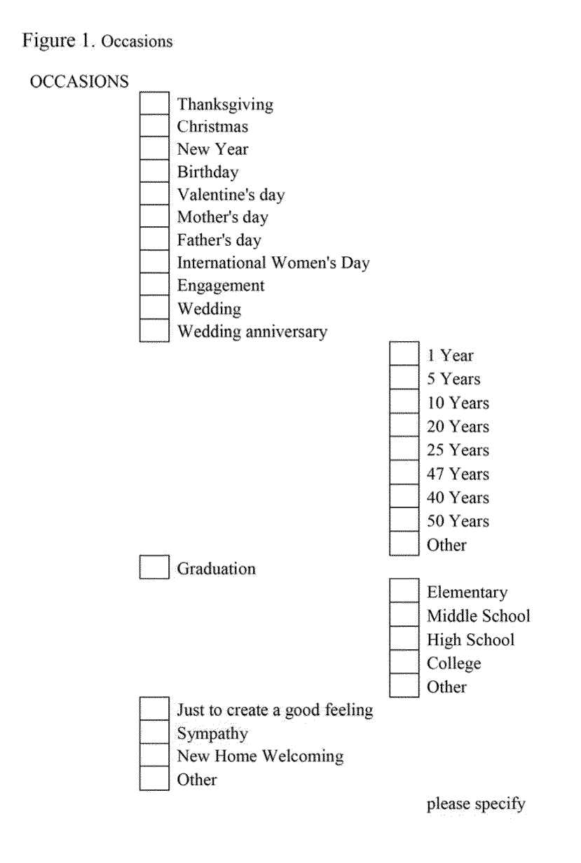

Step 1. Visitor selects occasion for a gift (FIG. 1). Occasions included, but not limited: Thanksgiving, Christmas, New Year, Birthday, Valentine's day, Mother's day, Father's day, International Women's Day, Engagement, Wedding, Wedding anniversary (1,5,10,20,25,30,40,50, Other), Graduation (Elementary School, Middle School, High School, College, Other), Just to create a good feeling, Sympathy, New Home Welcoming, Other (visitors can add other occasions).

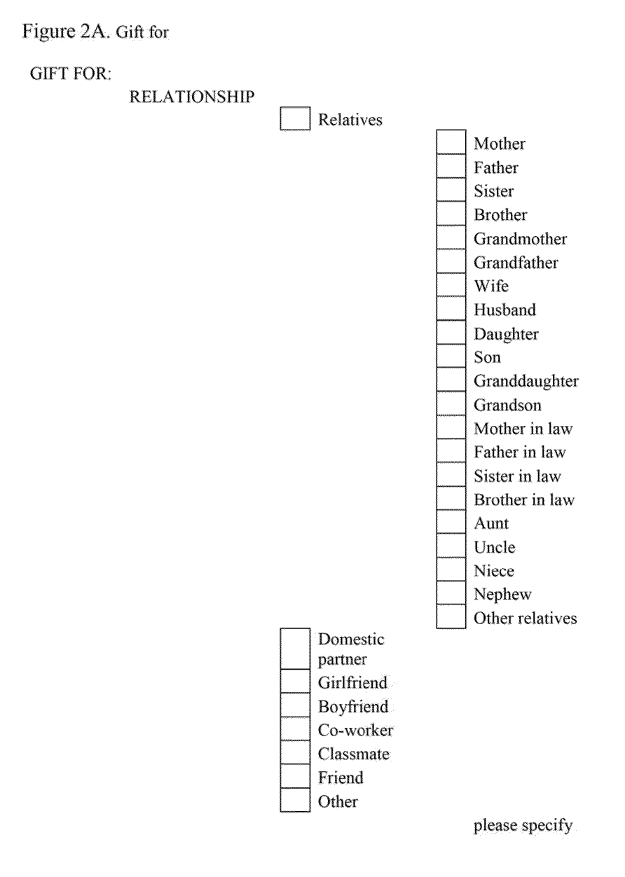

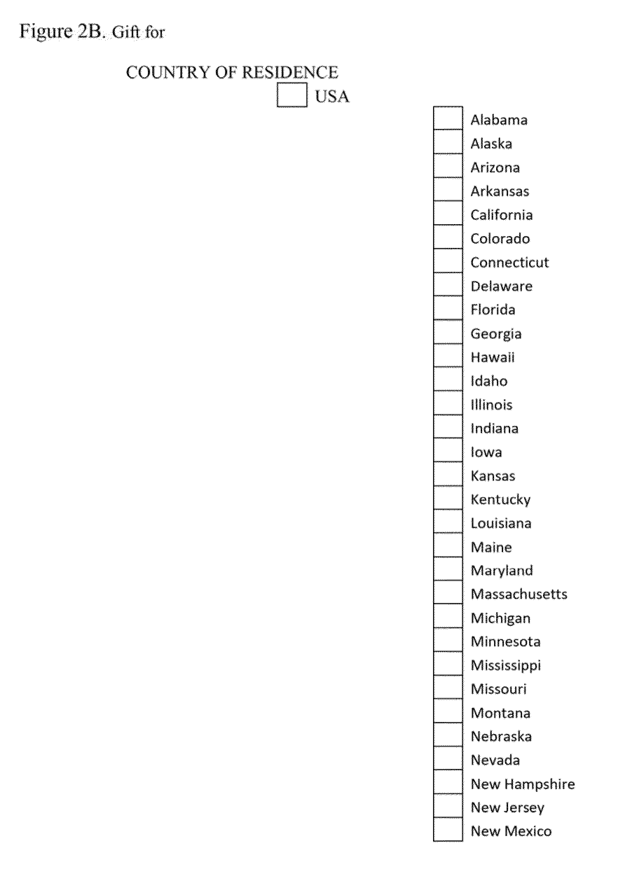

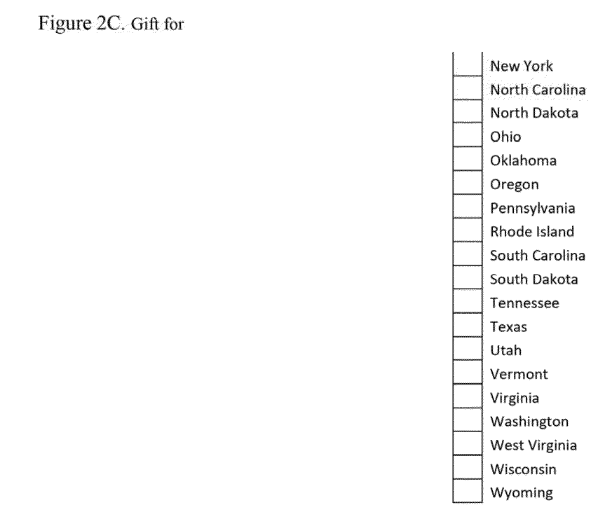

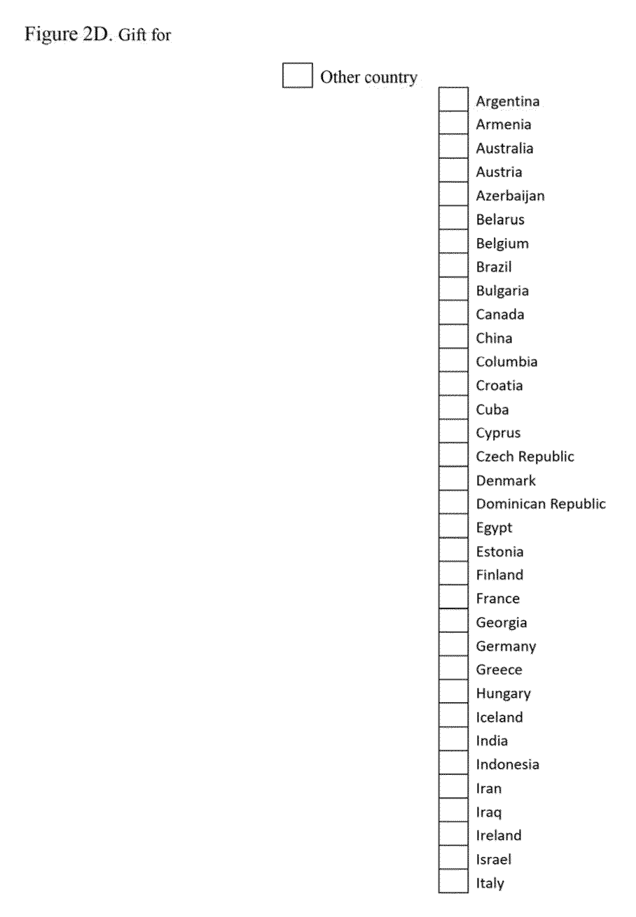

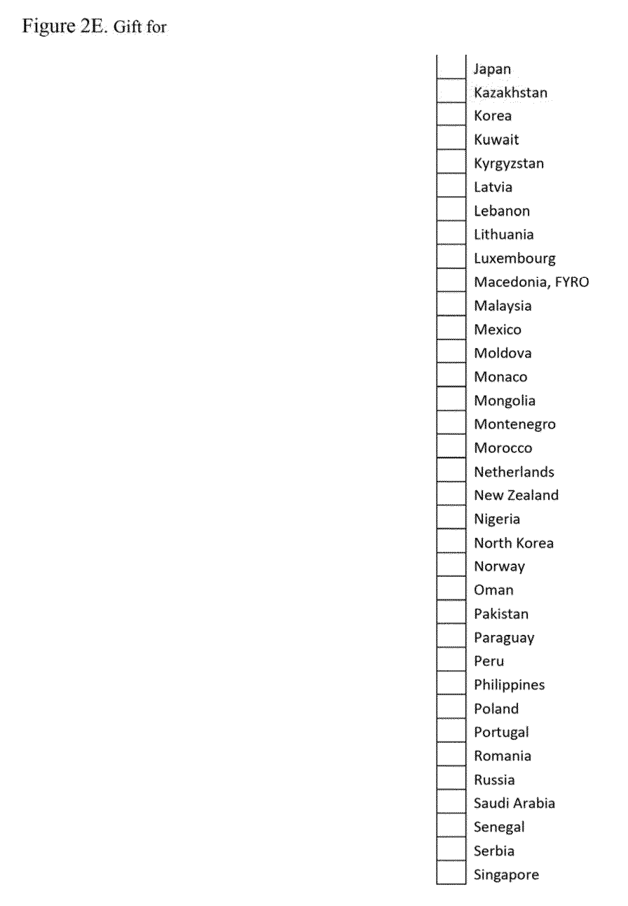

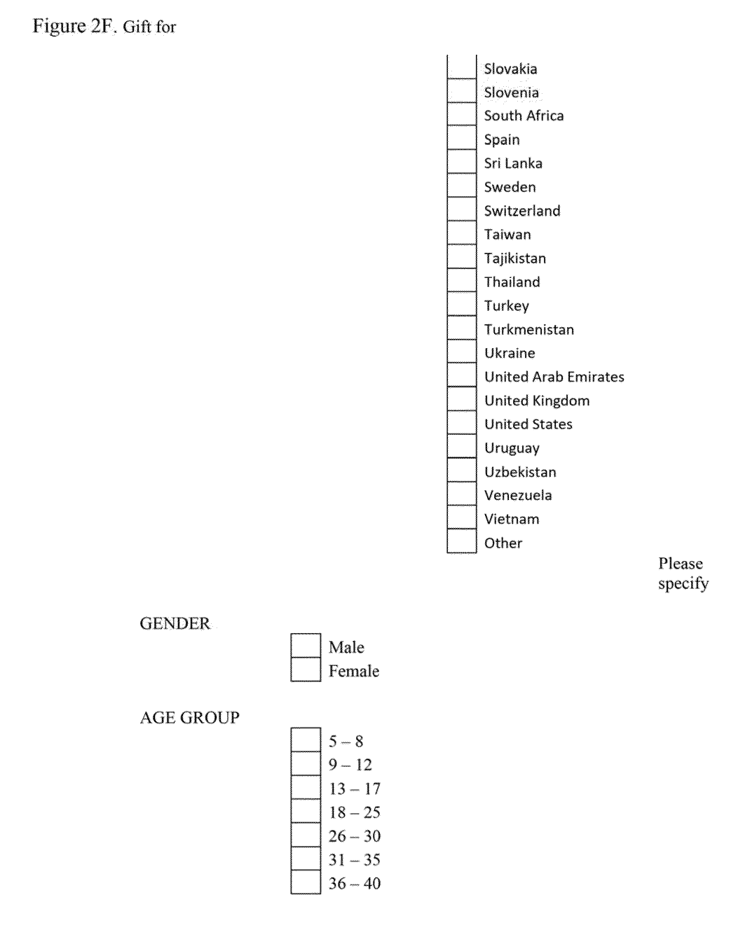

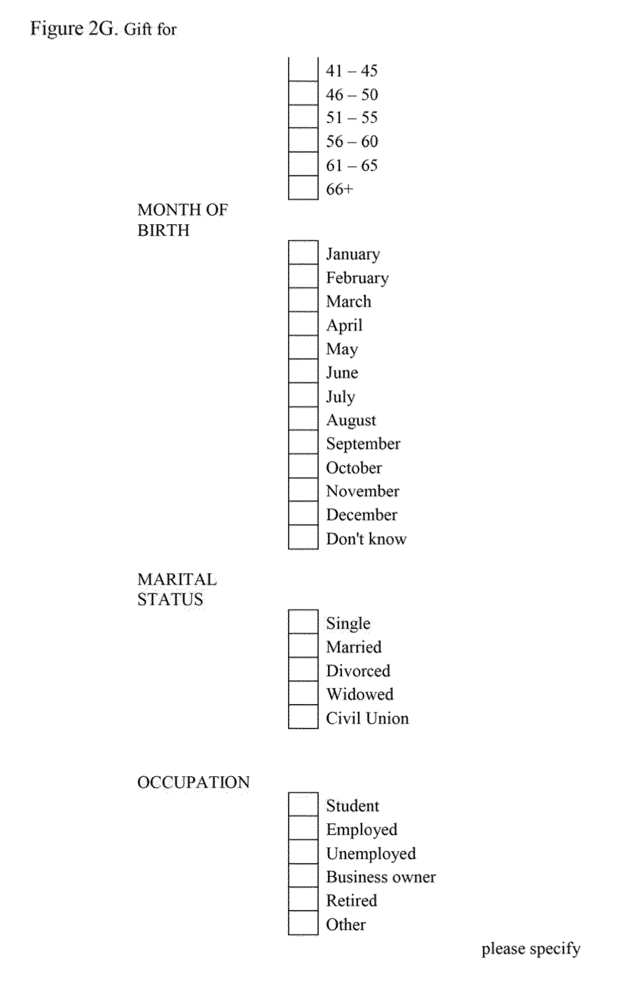

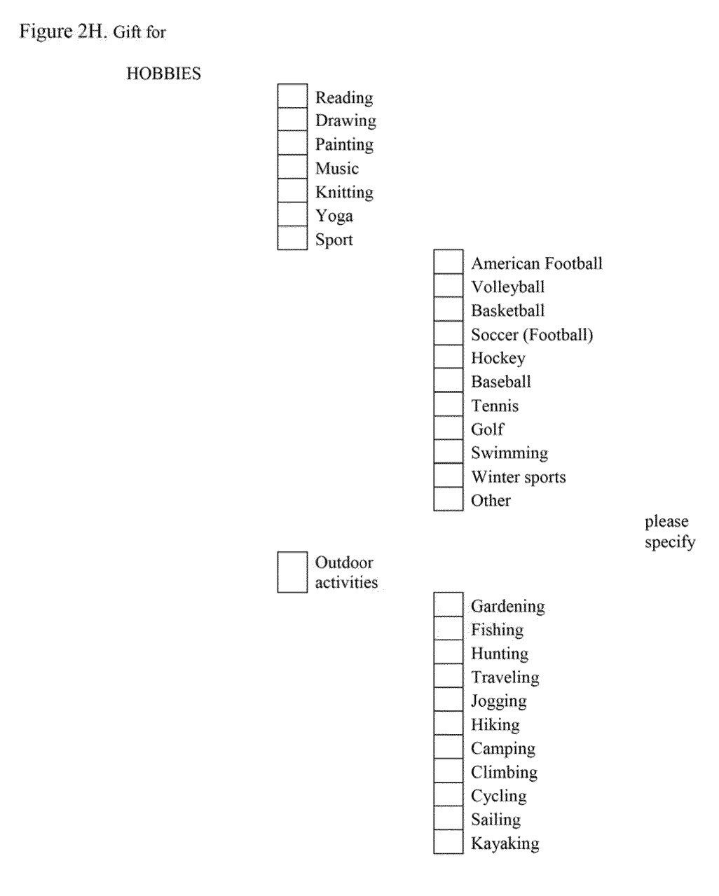

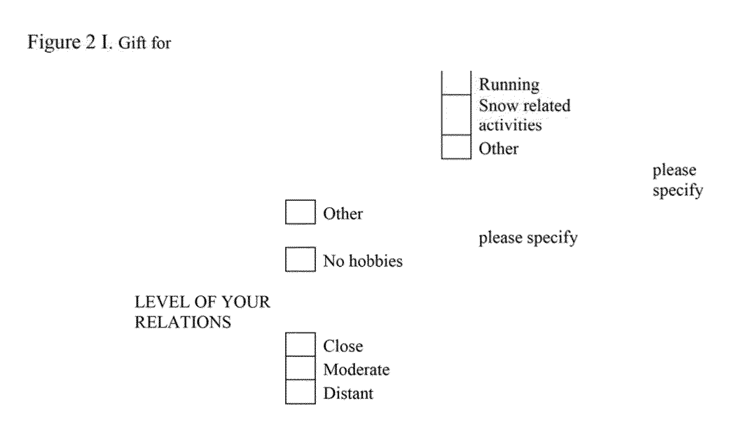

Step 2. Visitor enters general information about a gift recipient (FIGS. 2A, 2B, 2C, 2D, 2E, 2F, 2G, 2H, 2I). Gift for:

Relationship: Relatives (mother, father, sister, brother, grandmother, grandfather, wife, husband, daughter, son, granddaughter, grandson, mother in law, father in law, sister in law, brother in law, aunt, uncle, niece, nephew, other relatives); domestic partner, girlfriend, boyfriend, co-worker, classmate, friend, other;

Country of residence: USA (states also should be chosen: Alabama, Alaska, Arizona, Arkansas, California, Colorado, Connecticut, Delaware, Florida, Georgia, Hawaii, Idaho, Illinois, Indiana, Iowa, Kansas, Kentucky, Louisiana, Maine, Maryland, Massachusetts, Michigan, Minnesota, Mississippi, Missouri, Montana, Nebraska, Nevada, New Hampshire, New Jersey, New Mexico, New York, North Carolina, North Dakota, Ohio, Oklahoma, Oregon, Pennsylvania, Rhode Island, South Carolina, South Dakota, Tennessee, Texas, Utah, Vermont, Virginia, Washington, West Virginia, Wisconsin, Wyoming); Other countries (included but not limited Argentina, Armenia, Australia, Austria, Azerbaijan, Belarus, Belgium, Brazil, Bulgaria, Canada, China, Columbia, Croatia, Cuba, Cyprus, Czech Republic, Denmark, Dominican Republic, Egypt, Estonia, Finland, France, Georgia, Germany, Greece, Hungary, Iceland, India, Indonesia, Iran, Iraq, Ireland, Israel, Italy, Japan, Kazakhstan, Korea, Kuwait, Kyrgyzstan, Latvia, Lebanon, Lithuania, Luxembourg, Malaysia, Mexico, Moldova, Monaco, Mongolia, Montenegro, Morocco, Netherlands, New Zealand, Nigeria, North Korea, Norway, Oman, Pakistan, Paraguay, Peru, Philippines, Poland, Portugal, Romania, Russia, Saudi Arabia, Senegal, Serbia, Singapore, Slovakia, Slovenia, South Africa, Spain, Sri Lanka, Sweden, Switzerland, Taiwan, Tajikistan, Thailand, Turkey, Turkmenistan, Ukraine, United Arab Emirates, United Kingdom, Uruguay, Uzbekistan, Venezuela, Vietnam, other). New countries can be added if significant people from those countries visit website;

Gender (in the case if relationship category defines the gender, this question skips): male, female;

Age Group: 5-8, 9-12, 13-17, 18-25, 26-30, 31-35, 36-40, 41-45, 46-50, 51-55, 56-60, 61-65, 66 and over;

Month of birth: January, February, March, April, May, June, July, August, September, October, November, December (visitor can skip this question, however on this case gift choice preferences according to the month of birth of recipients will not be available);

Marital Status (this information appears for ages 18 and above): single, married, divorced, widowed, civil union;

Occupation (this information appears for ages 18 and above): student, employed, unemployed, business owner, retired, other;

Hobbies: reading, drawing, painting, music, knitting, yoga, sport (included American football, volleyball, basketball, soccer (football), hockey, baseball, tennis, golf, swimming, winter sports, other), outdoor activities (included gardening, fishing, hunting, traveling, jogging, hiking, camping, climbing, cycling, sailing, kayaking, running, snow related activities, other), other, no hobbies;

Level of relationship: close, moderate, distant.

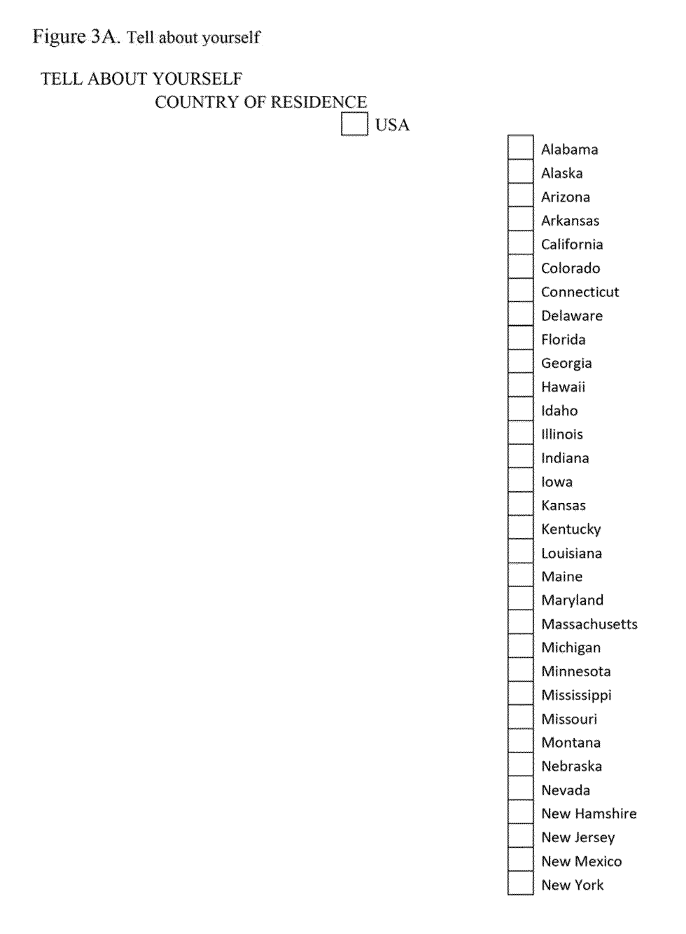

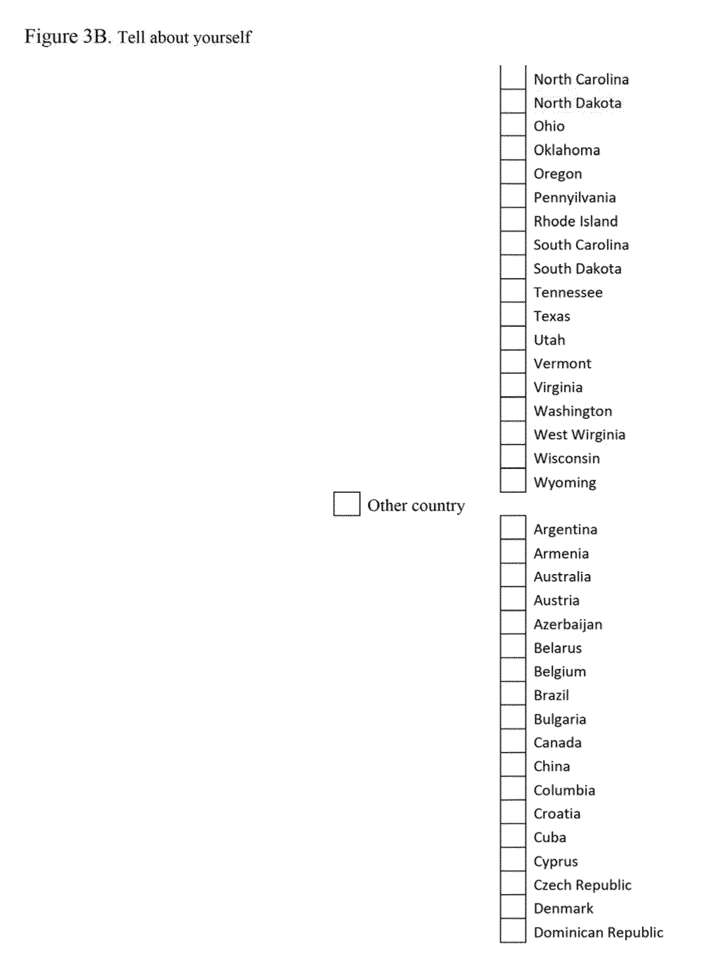

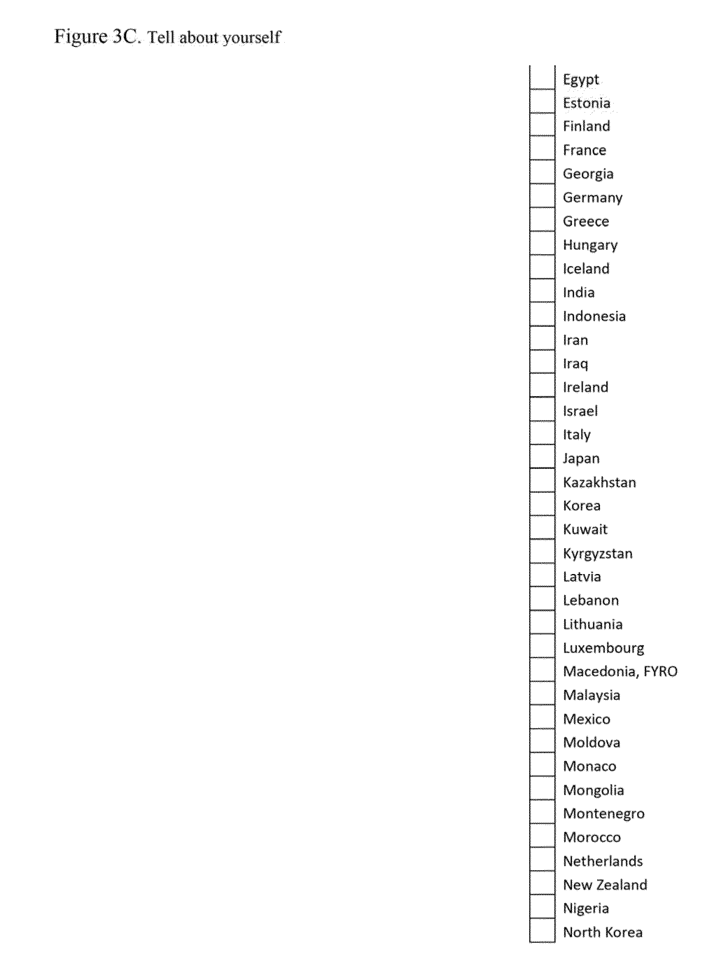

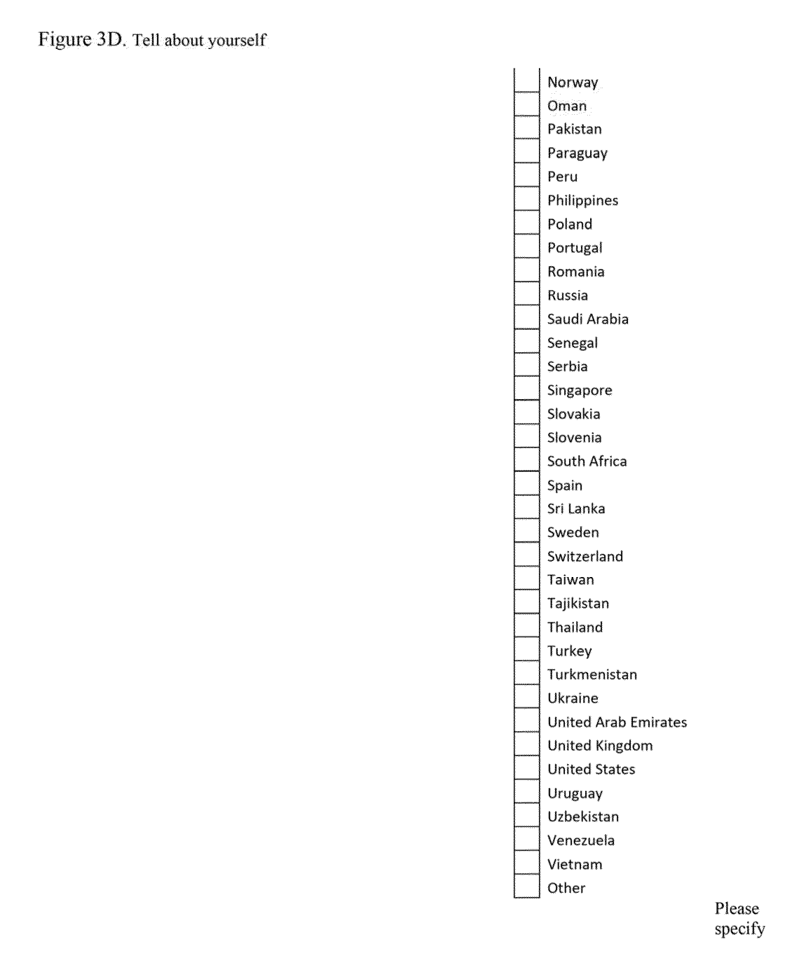

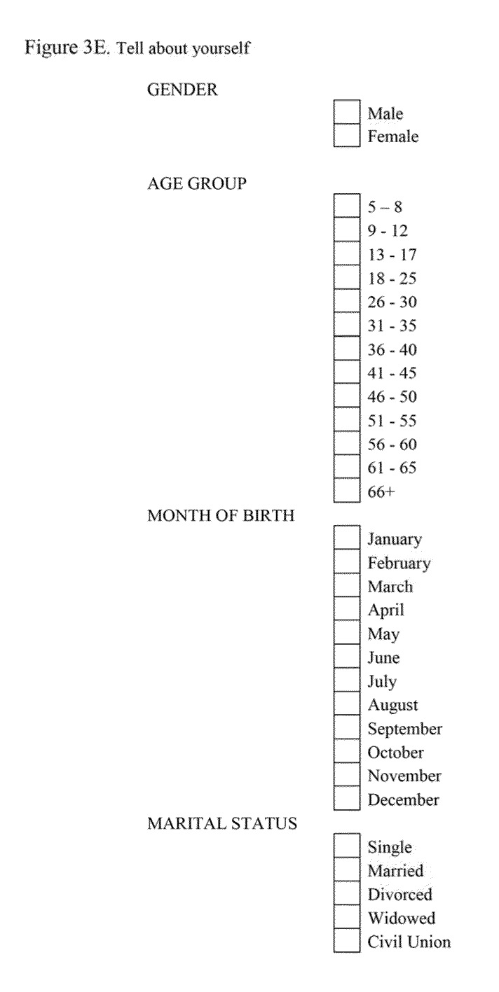

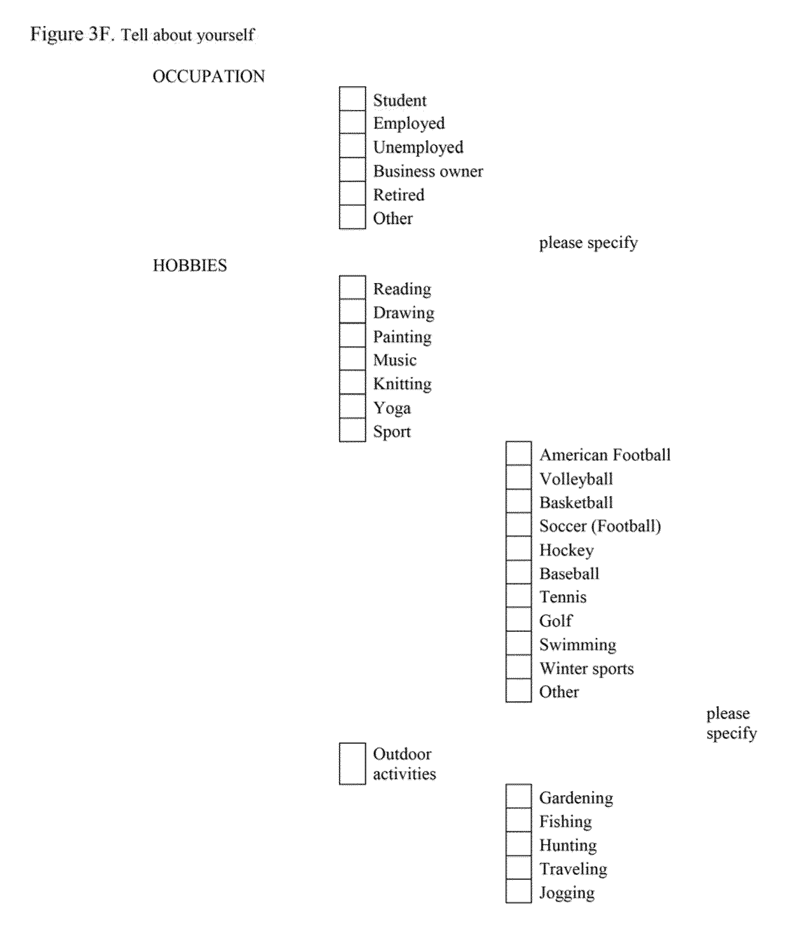

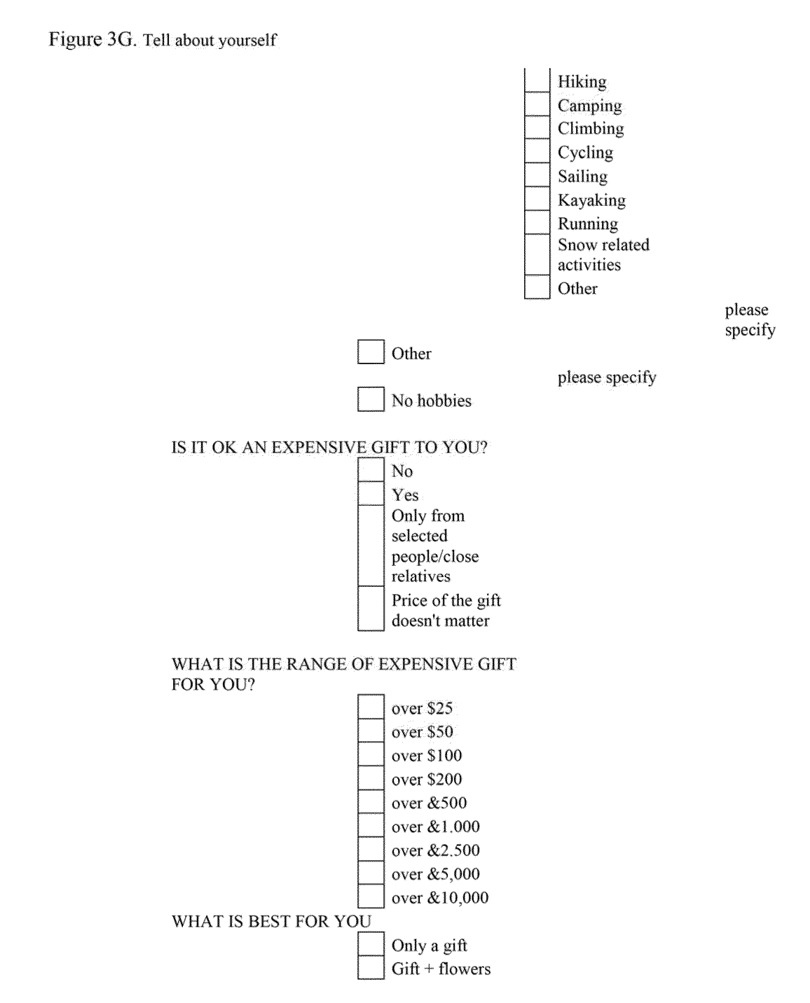

Step 3. Visitor enters general information about himself/herself (FIGS. 3A, 3B, 3C, 3D, 3E, 3F, 3G).

Country of residence: USA (states also should be chosen: Alabama, Alaska, Arizona, Arkansas, California, Colorado, Connecticut, Delaware, Florida, Georgia, Hawaii, Idaho, Illinois, Indiana, Iowa, Kansas, Kentucky, Louisiana, Maine, Maryland, Massachusetts, Michigan, Minnesota, Mississippi, Missouri, Montana, Nebraska, Nevada, New Hampshire, New Jersey, New Mexico, New York, North Carolina, North Dakota, Ohio, Oklahoma, Oregon, Pennsylvania, Rhode Island, South Carolina, South Dakota, Tennessee, Texas, Utah, Vermont, Virginia, Washington, West Virginia, Wisconsin, Wyoming); Other countries (included but not limited Argentina, Armenia, Australia, Austria, Azerbaijan, Belarus, Belgium, Brazil, Bulgaria, Canada, China, Columbia, Croatia, Cuba, Cyprus, Czech Republic, Denmark, Dominican Republic, Egypt, Estonia, Finland, France, Georgia, Germany, Greece, Hungary, Iceland, India, Indonesia, Iran, Iraq, Ireland, Israel, Italy, Japan, Kazakhstan, Korea, Kuwait, Kyrgyzstan, Latvia, Lebanon, Lithuania, Luxembourg, Malaysia, Mexico, Moldova, Monaco, Mongolia, Montenegro, Morocco, Netherlands, New Zealand, Nigeria, North Korea, Norway, Oman, Pakistan, Paraguay, Peru, Philippines, Poland, Portugal, Romania, Russia, Saudi Arabia, Senegal, Serbia, Singapore, Slovakia, Slovenia, South Africa, Spain, Sri Lanka, Sweden, Switzerland, Taiwan, Tajikistan, Thailand, Turkey, Turkmenistan, Ukraine, United Arab Emirates, United Kingdom, Uruguay, Uzbekistan, Venezuela, Vietnam, other). New countries can be added if significant people from those countries visit website;

Gender: male, female;

Age Group: 5-8, 9-12, 13-17, 18-25, 26-30, 31-35, 36-40, 41-45, 46-50, 51-55, 56-60, 61-65, 66 and over;

Month of birth: January, February, March, April, May, June, July, August, September, October, November, December;

Marital Status (this information appears for ages 18 and above): single, married, divorced, widowed, civil union;

Occupation (this information appears for ages 18 and above): student, employed, unemployed, business owner, retired, other;

Hobbies: reading, drawing, painting, music, knitting, yoga, sport (included American football, volleyball, basketball, soccer (football), hockey, baseball, tennis, golf, swimming, winter sports, other), outdoor activities (included gardening, fishing, hunting, traveling, jogging, hiking, camping, climbing, cycling, sailing, kayaking, running, snow related activities, other), other, no hobbies;

Is it ok an expensive gift to you (appears for ages 13 and above): no, yes, only from selected people/close relatives, price of the gift doesn't matter.

What is the range of expensive gift perception for you (appears for ages 13 and above): over $25, over $50, over $100, over $200, over $500, over $1000, over $2500, over $5000, over $10000;

What is best for you (appears for ages 13 and above): only a gift, gift+flowers.

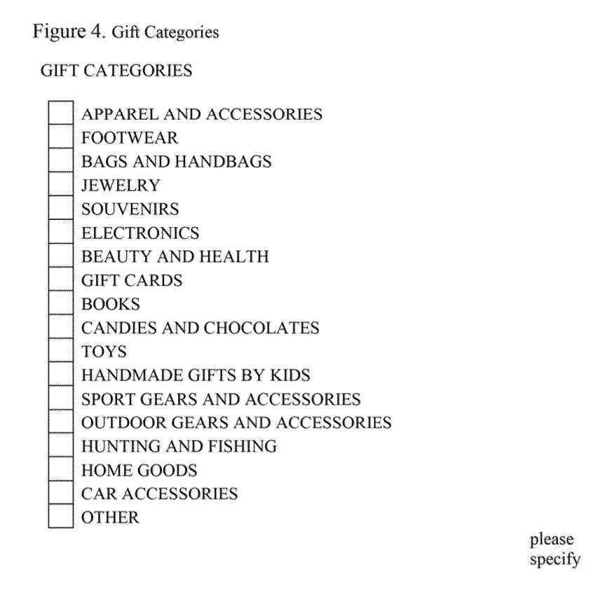

Step 4. Website visitor chooses desired gift (assumed) for himself/herself using the presented Gift Catalog on the same occasion from the person whom he/she is seeking a gift for. An exception: kids under age 18 when look for a gift for somebody on the occasion of Wedding and Wedding anniversary, choose instead a gift for himself/herself on a Graduation occasion appropriate to their ages (website prompts them to the relevant occasion automatically). On the opposite, when people over age 25 look for a gift for somebody on a Graduation occasion, they choose instead a gift for himself/herself on Wedding anniversary if marred or Wedding occasion if single (website prompts them to the relevant occasion automatically). On the top of the page information based on the preliminary entered information by visitor appears: Choose gift for yourself from (gift recipient) on (occasion). By clicking Next website visitor forwards to the Gift Catalog (FIG. 4). Gift Catalog included, but not limited following Gift Categories and items:

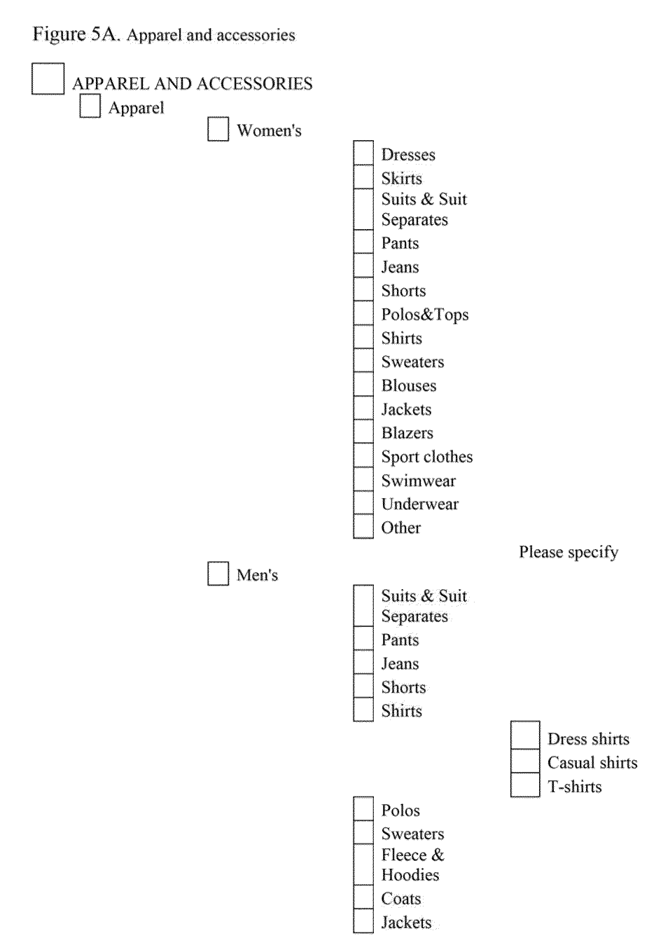

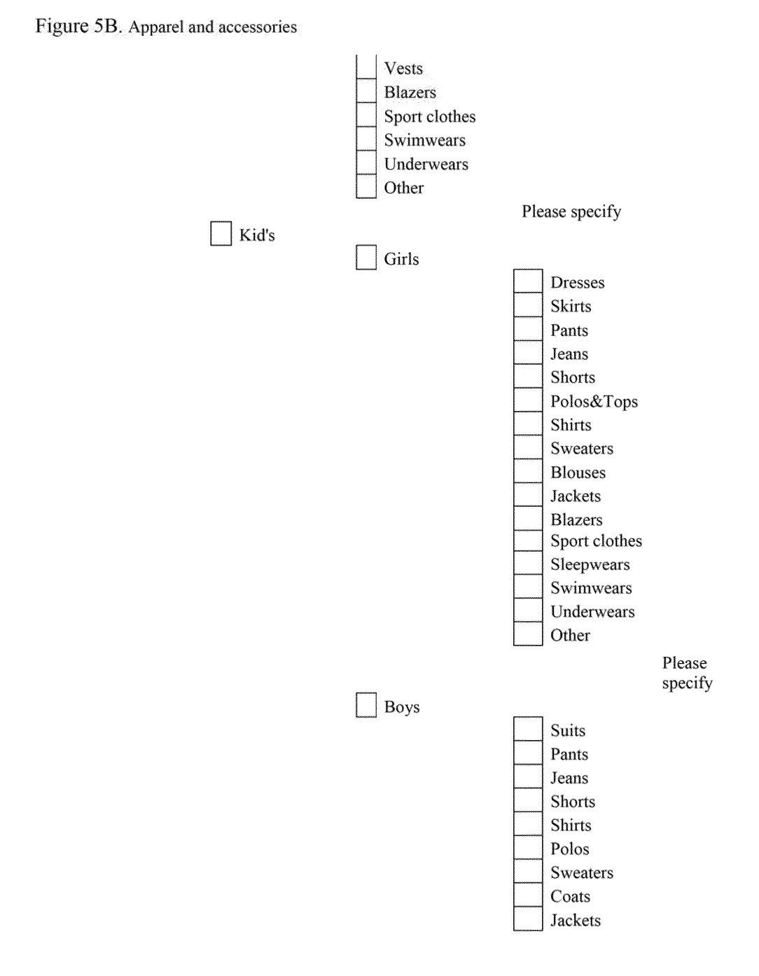

Apparel and accessories. FIGS. 5A, 5B, 5C, 5D describes gift choice options for Apparel and accessories Category.

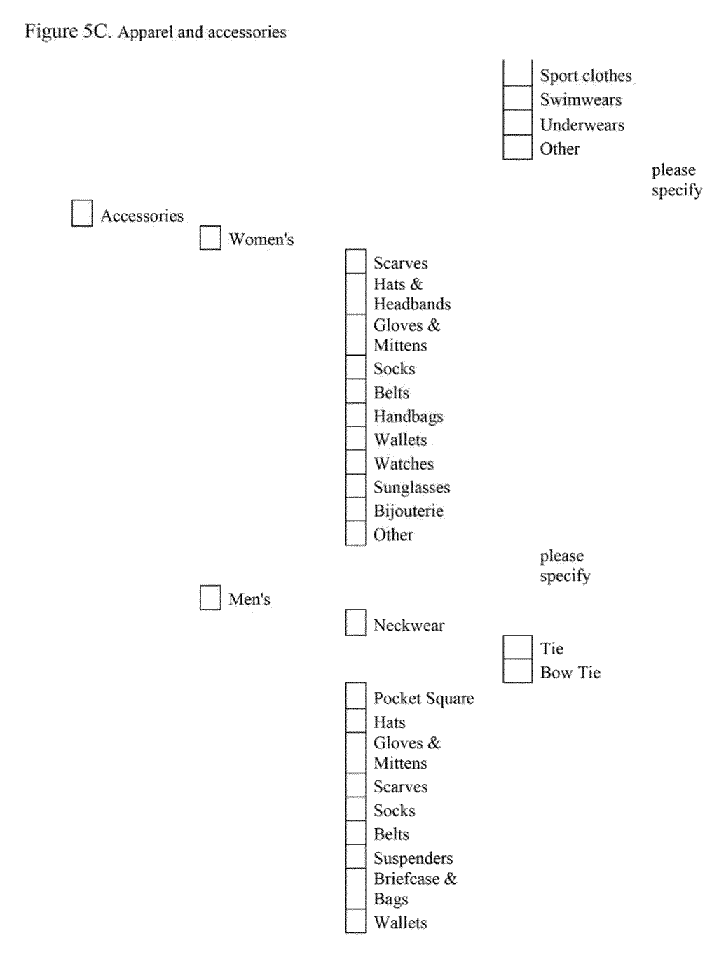

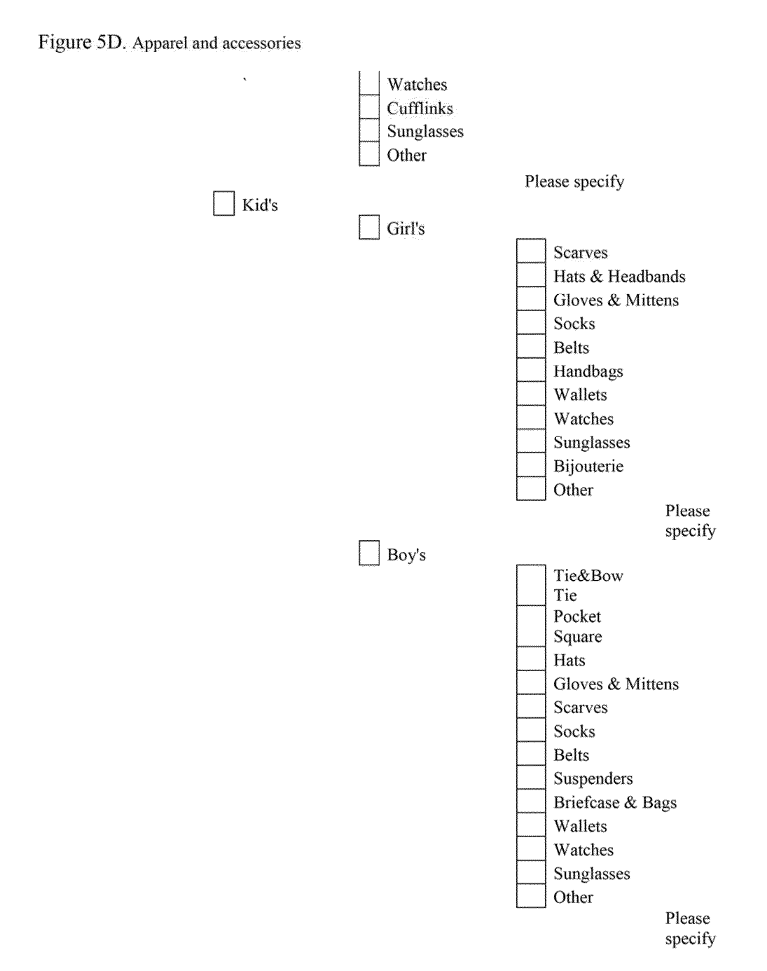

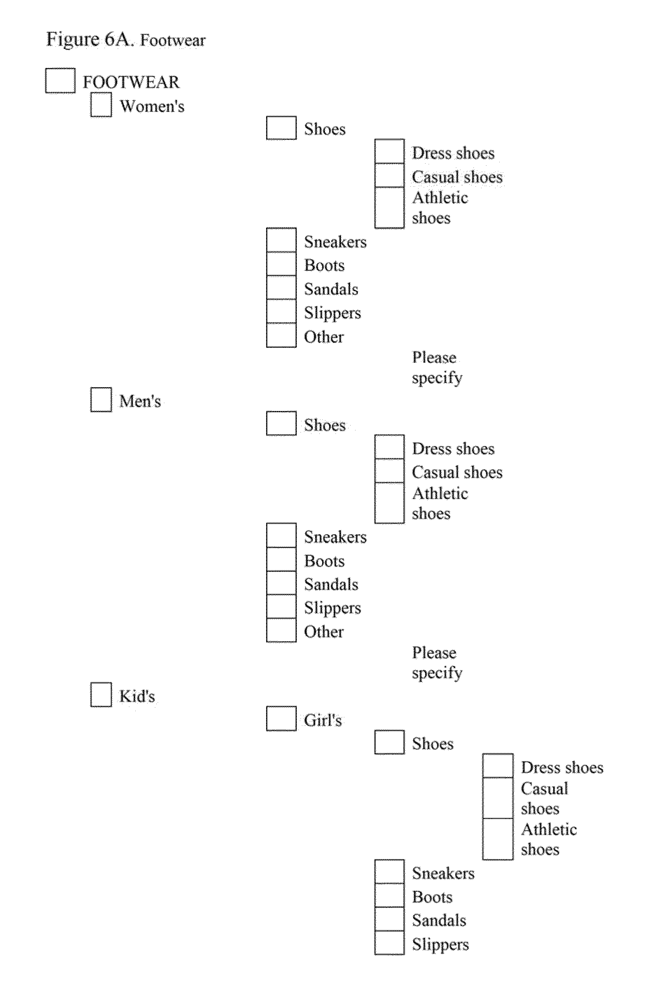

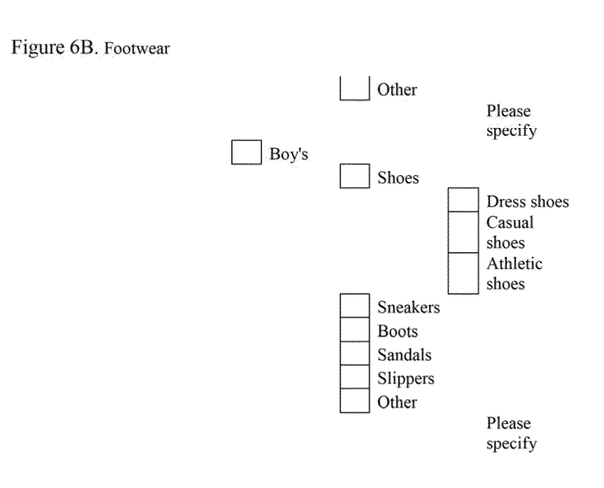

Footwear. FIGS. 6A, 6B describes gift choice options for Footwear Category.

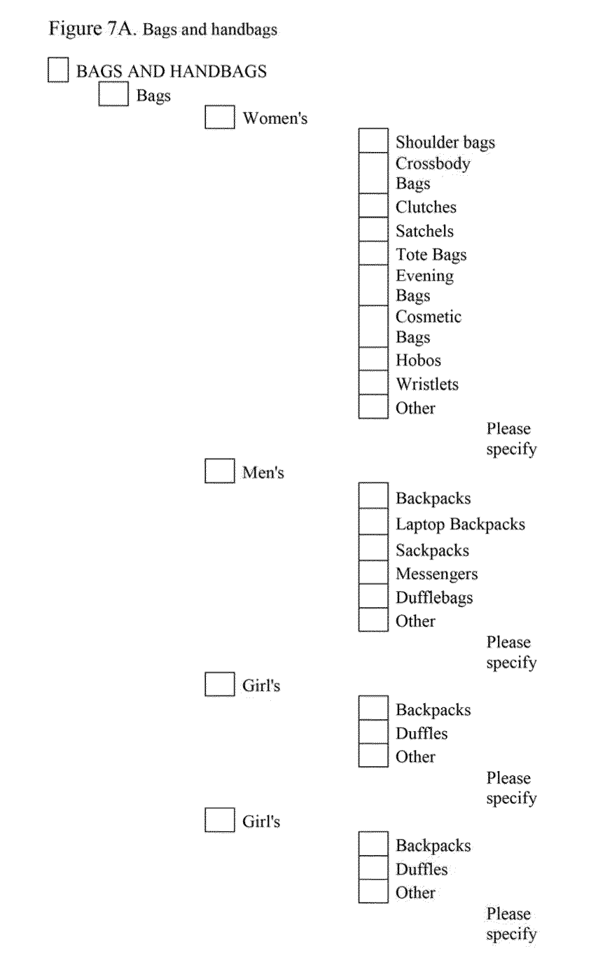

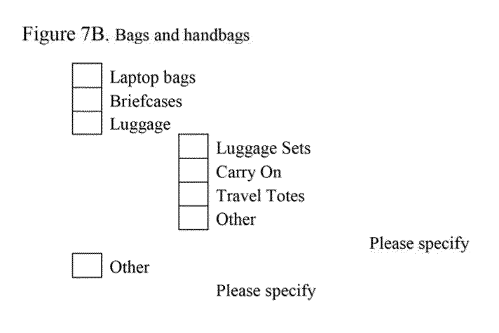

Bags and handbags. FIGS. 7A, 7B describes gift choice options for Bags and handbags Category.

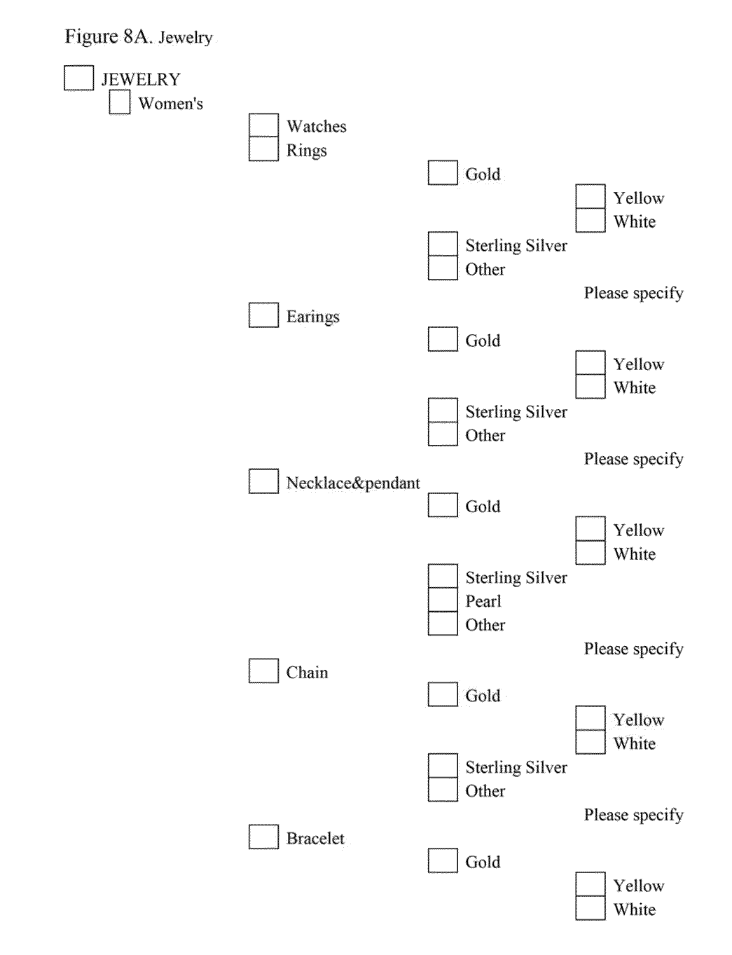

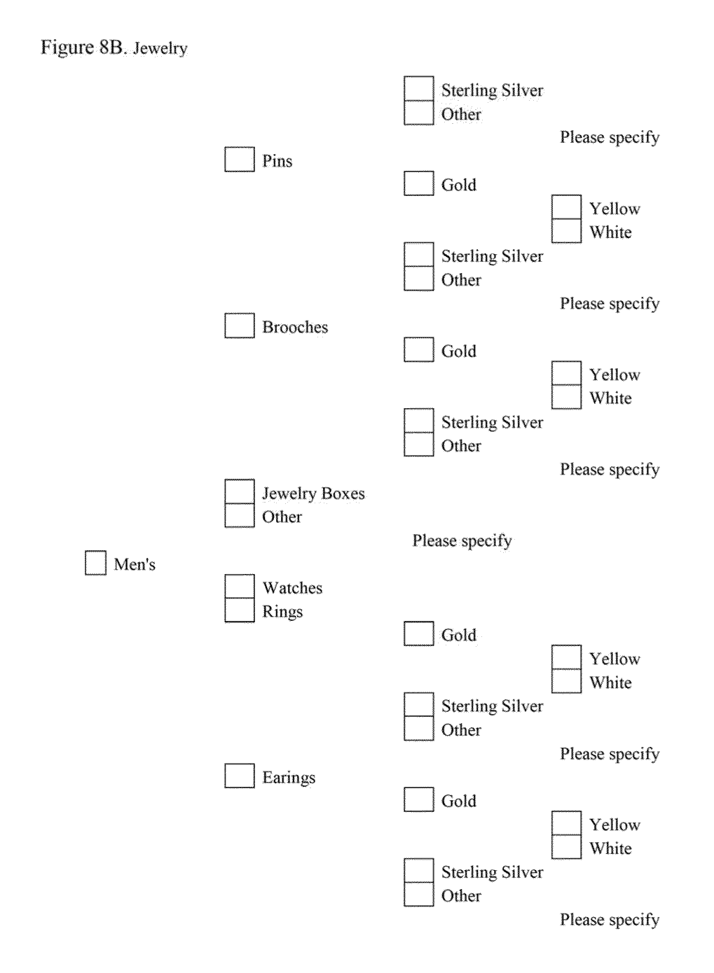

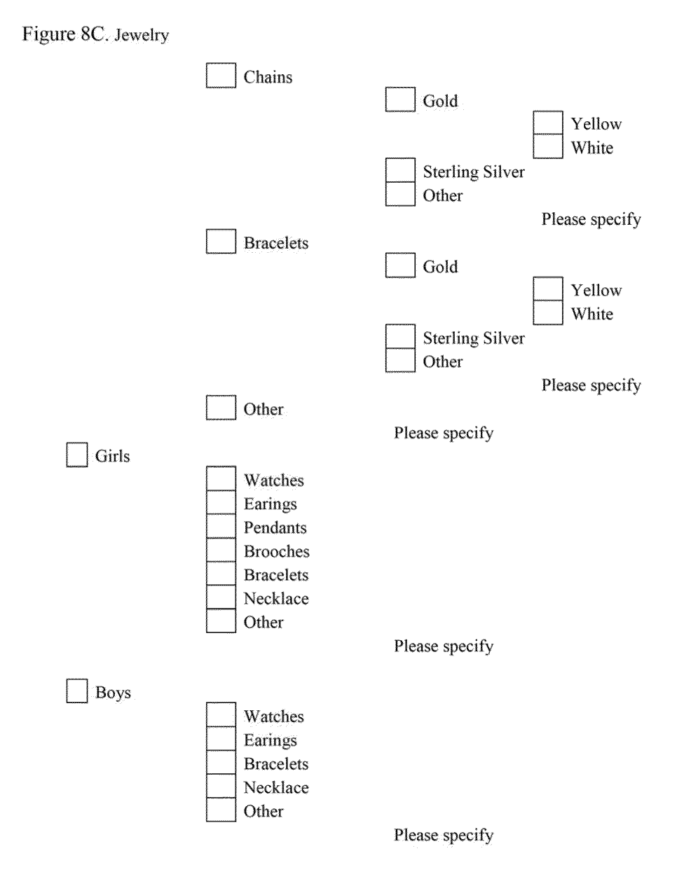

Jewelry. FIGS. 8A, 8B, 8C describes gift choice options for Jewelry Category.

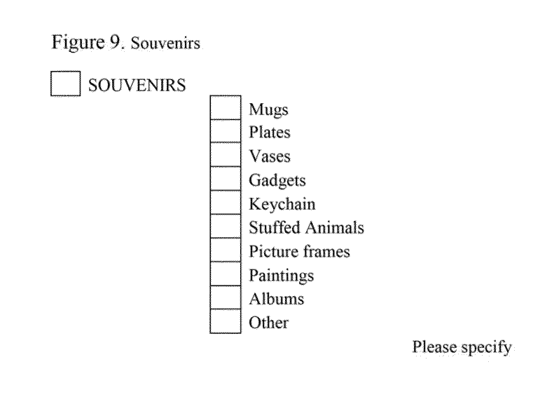

Souvenirs. FIG. 9 describes gift choice options for Souvenirs Category.

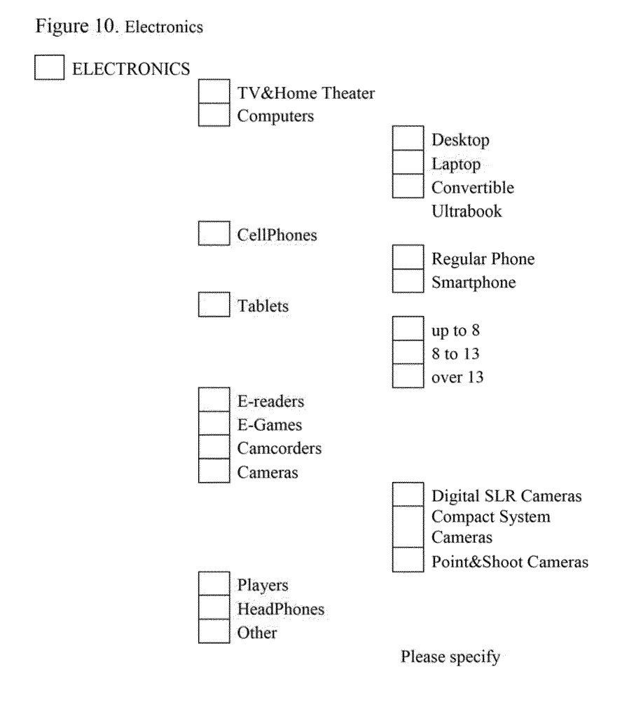

Electronics. FIG. 10 describes gift choice options for Electronics Category.

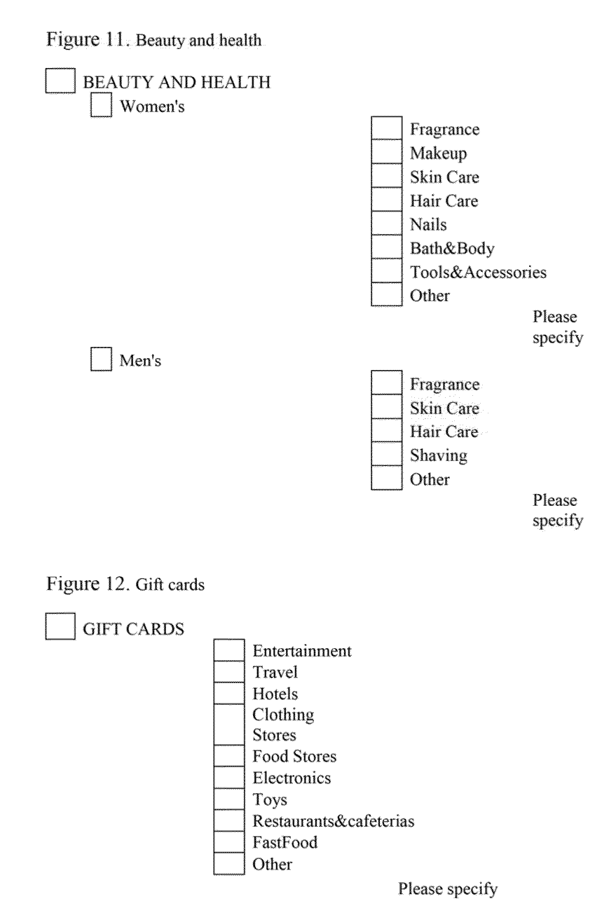

Beauty and health. FIG. 11 describes gift choice options for Beauty and health Category.

Gift cards. FIG. 12 describes gift choice options for Gift cards Category.

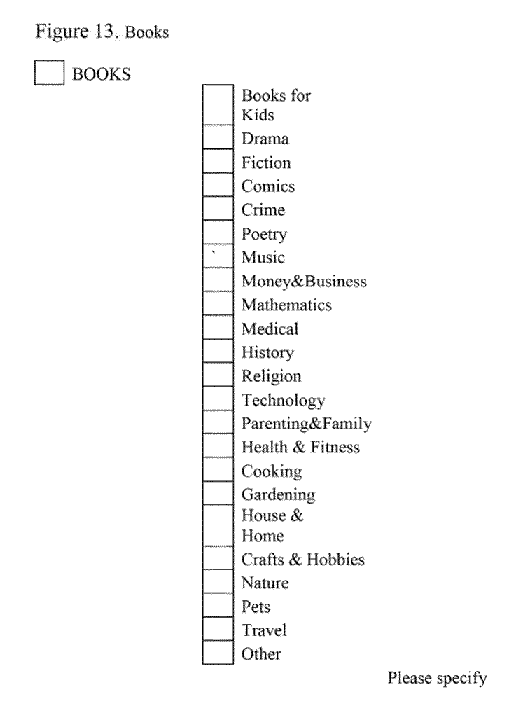

Books. FIG. 13 describes gift choice options for Books Category.

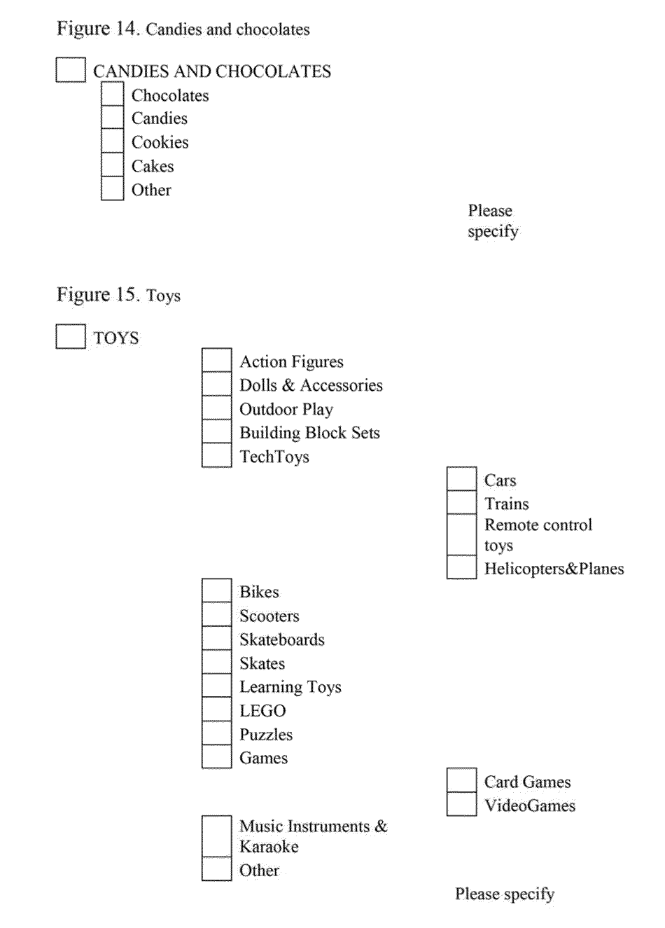

Candies and chocolates. FIG. 14 describes gift choice options for Candies and chocolates Category.

Toys. FIG. 15 describes gift choice options for Toys Category.

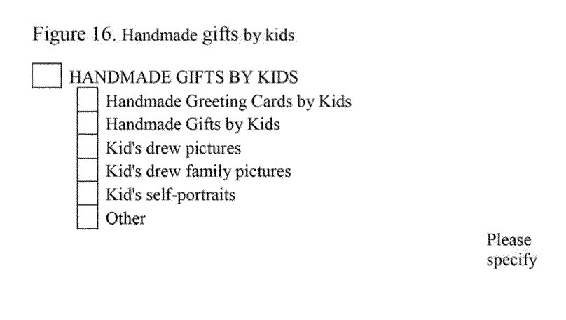

Handmade gifts by kids. FIG. 16 describes gift choice options for Handmade gifts by kids Category.

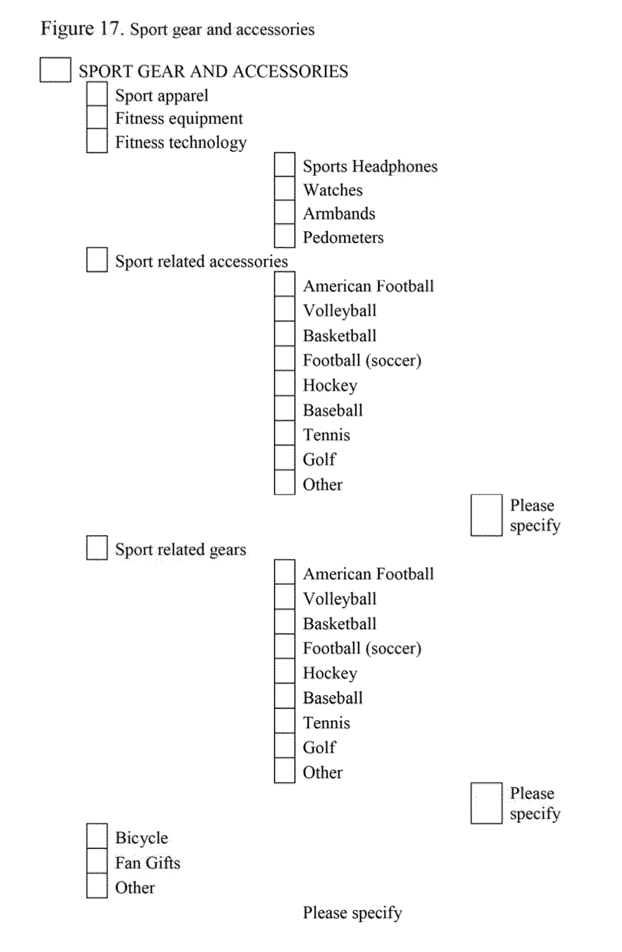

Sport gear and accessories. FIG. 17 describes gift choice options for Sport gear and accessories Category.

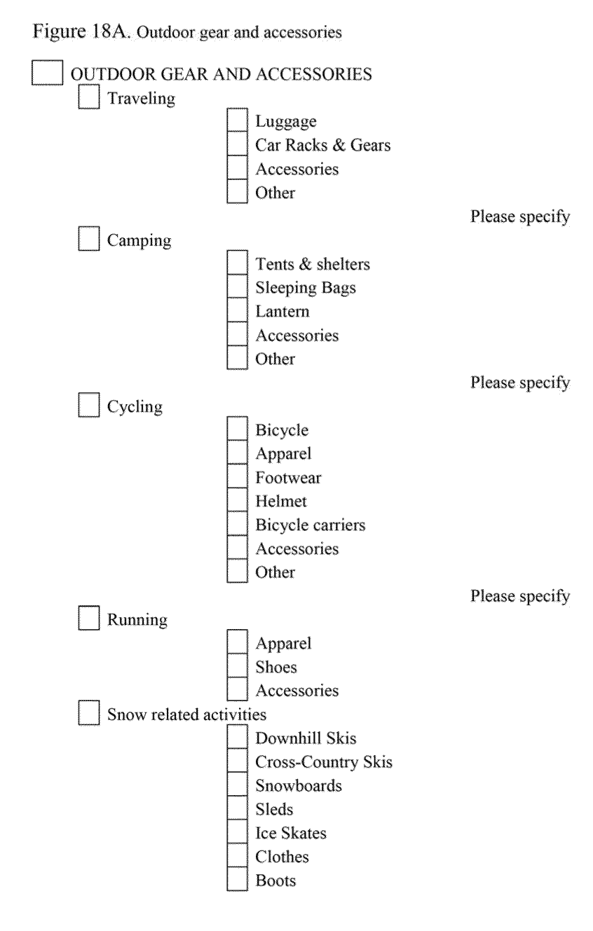

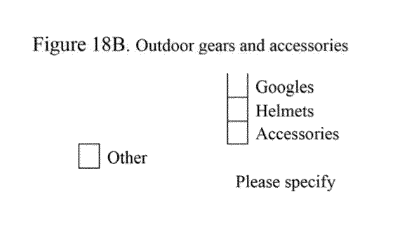

Outdoor gear and accessories. FIGS. 18A, 18B describes gift choice options for Outdoor gear and accessories Category.

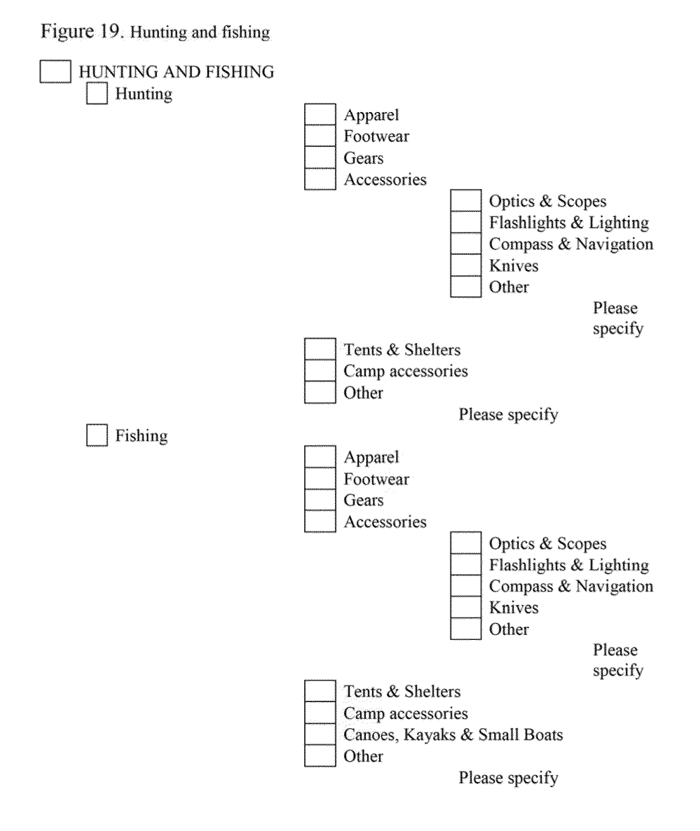

Hunting and fishing. FIG. 19 describes gift choice options for Hunting and fishing Category.

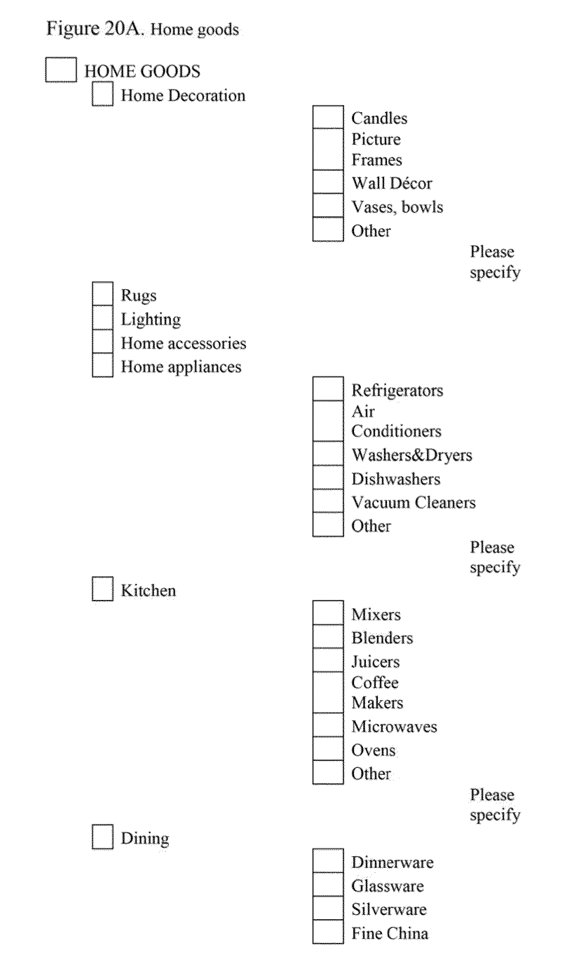

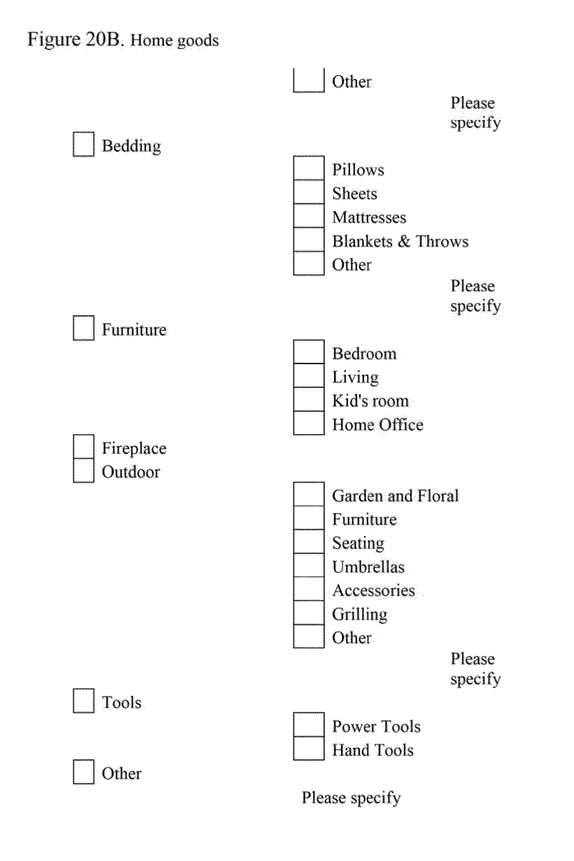

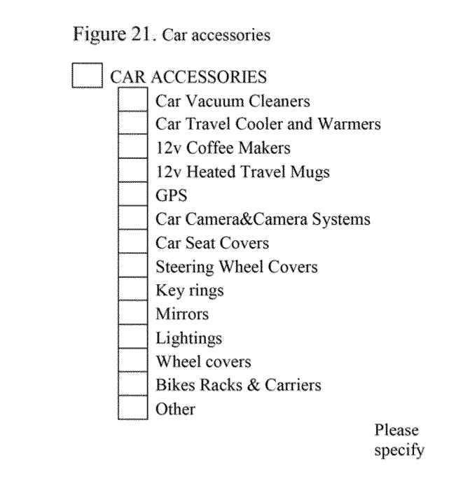

Home goods. FIGS. 20A, 20B describes gift choice options for Home goods Category. Car accessories. FIG. 21 describes gift choice options for Car accessories Category.

Other. Visitors can enter desired gift categories or items not existed in the Gift Catalog using Other options. When a significant number of the same item is added, item can be included in the Gift Catalog.

When visitor finalizes desired gift (assumed) choice for himself/herself using Gift Catalog, he/she is granted an access to the Database.

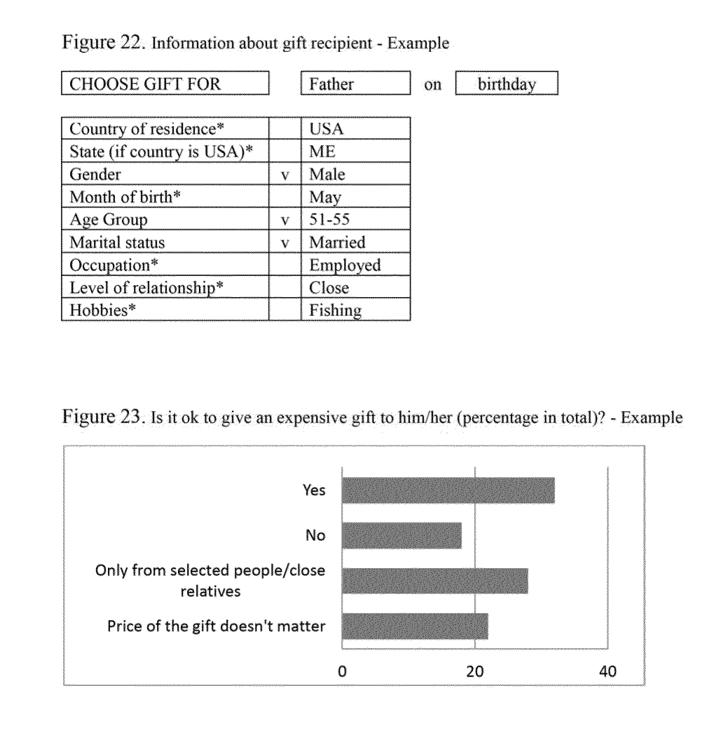

Step 5. Database. When an access to database is granted, following information appears on the top of the page based on the preliminary entered information by visitor (FIG. 22): Choose gift for (gift recipient) on (occasion), country of residence (state also if the country is USA)*, month of birth*, age group, marital status (for people under age18 this information skips), occupation, level of relationship*, hobbies* (for kids under age 13 this information skips). Information marked with asterisk is optional and visitors can able or disable these criteria, choosing more specific or generalized information.

When the process to set criteria for a specific group of people which gift recipient belongs is finalized, on the base of the selected characteristics following 3 graphs appears on the screen, which gives supplementary information to help choosing a gift and presenting it:

1) Is't ok to give an expensive gift for him/her (appears for ages 13 and above, FIG. 23)—this graph indicates attitude of recipients to expensive gift by options: no; yes; only from selected people/close relatives; price of the gift doesn't matter.

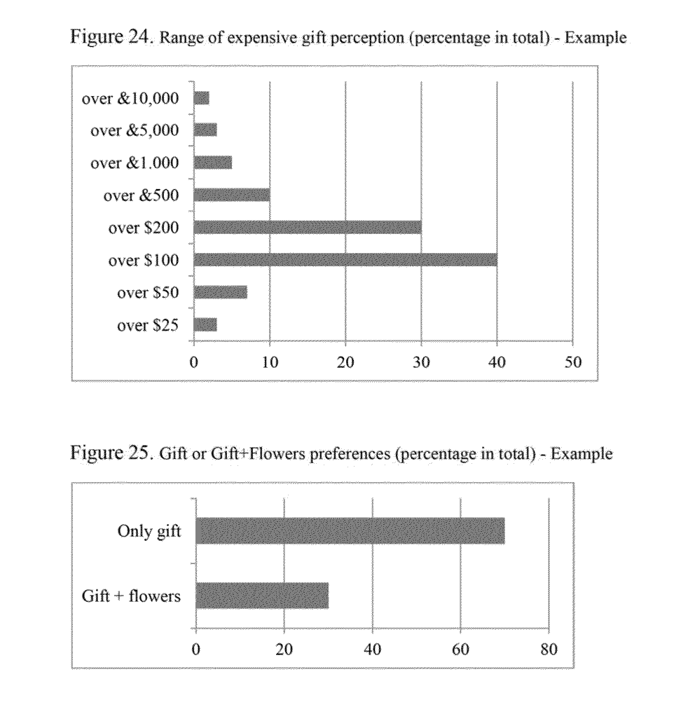

2) Range of expensive gift perception (appears for ages 13 and above, FIG. 24)—this graph indicates expensive gift perception of recipients by options: over $25, over $50, over $100, over $200, over $500, over $1000, over $2500, over $5000, over $10000.

3) Gift or Gift+Flowers preferences (appears for ages 13 and above, FIG. 25)—this graph indicates the attitude of recipients to a gift and gift+flowers option.

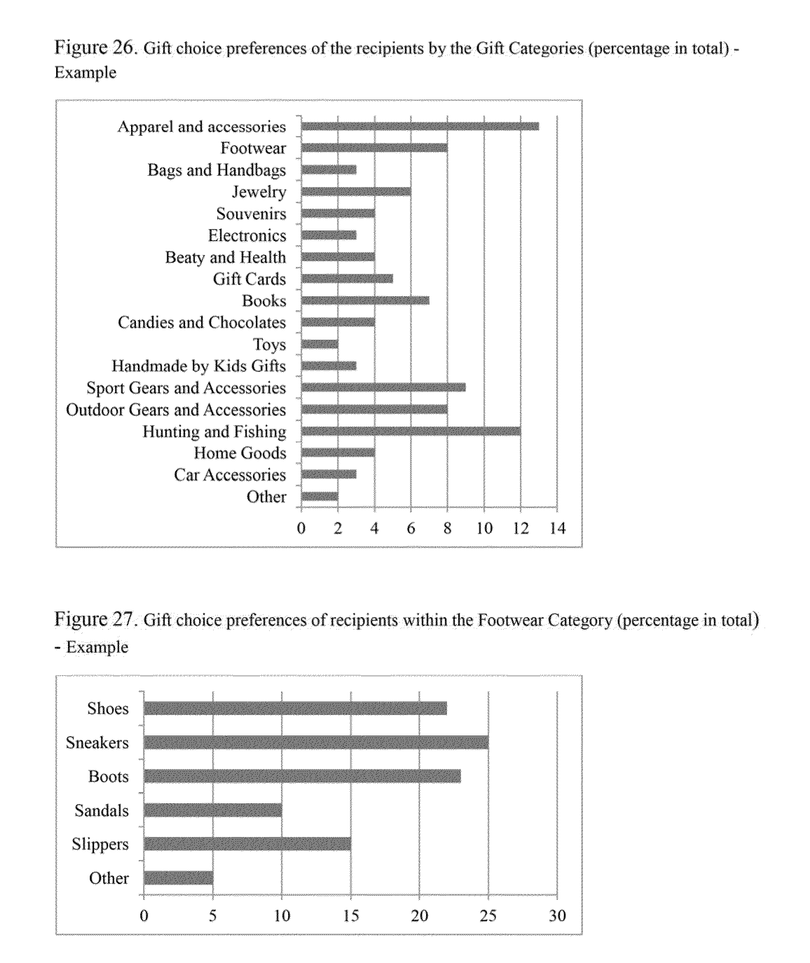

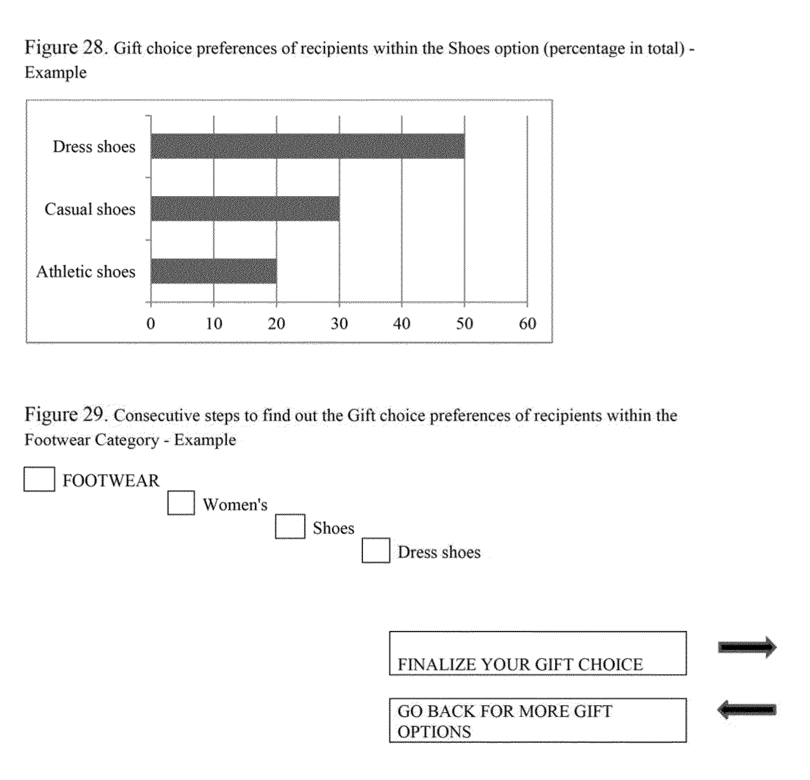

After getting supplementary information about gift recipient's general opinion on the issues mentioned above, visitor uses next steps to get generalized information about gift choice preferences of a specific group of people according to already defined criteria. First, on the screen appears the Graph that indicates gift choice preferences of the selected group of people by Gift Categories as percentage in total (FIG. 26). Visitor can choose any of the gift categories to get more detailed information within the category. After choosing any Gift Category next Graph appears displaying proportion of gift choice preferences within a gift category (FIGS. 27, 28). Depending of a gift structure within each Gift Category, numbers of Graphs displaying Subcategories may vary. So, visitor chooses Gift Category, Subcategory and etc. until finalize process to get information about recipients gift choice preferences (FIG. 29). At the end of this process, visitor has a choice of going back in order to explore more options within other gift categories or finalizing it.

After getting necessary information about the gift choice preferences of the gift recipient and supplementary information, visitor will be well informed and ready to take next steps to buy a gift, through online or visiting the stores.

In order to take into account changes in the assortments and options for the gift, as well as general trends in this sphere, timeframe for the Database information to be active can be determined. Inputs by the visitors to the Other option of the gift categories, as well as within each category will be analyzed by the provider and necessary adjustment will be made taken into account visitors expectations to the Gift Categories and within categories.

The Database program extracts and provides appropriate information on gift choice preferences of the recipients according to the criteria chosen by visitors. Sometimes, especially at the beginning stage of the activation of the Database (accumulation period), some information may not be available. On these cases:
when for the USA information by chosen state is not available (database doesn't have enough entries), total information for the USA offers; when information according to the chosen country is not available, general information for all countries offers;
when information on specific occasion and relationship are not available, general information on the gift choice preferences of the same age group offers;
when information according to the exact age group is not available, close age group or total age group gift choice preferences offers;
when information according to the selected month of birth is not available, general information for the selected age group offers;
when information according to marital status, occupation, level of relationship, hobbies are not available, general information on gift choice preferences of the specific age group offers.

### Nomenclature

Database—Online Interactive Database on Gift Choice Preferences of Recipients;

Visitor—website visitor, who looks for a gift for somebody;

Recipient—gift recipient;

Desired gift—is a gift which website visitor would expect on the same occasion and from the same person whom actually he or she is looking for a gift.

1. The system allowing to generate information on gift choice preferences of recipients, to classify, summarize, store it in the database, and to extract and display information from the database according to criteria chosen including: a server computer; a provider computer coupled to the server computer; the website visitor computer, tablet and other mobile devices coupled to the server computer; a database stored on the server computer; an instruction stored on the server computer that when executed on the server computer perform a method including;
accepting information on occasion for a gift;
accepting general information on a gift recipient;
accepting general information on a website visitor;
accepting information on a desired (assumed) gift choice of the visitor;
classifying, summarizing and storing accepted information in the database;
granting access to the database after prerequisite of desired gift choice b visitor met;
extracting information from the database on gift choice preferences of recipients according to the criteria set by visitor and displaying it.

2. The method to generate information on gift choice preferences of recipients for the database: choosing a desired gift (assumed) for himselfherself from the person whom visitor looks for a gift (recipient);

[symbol]

3. The method to generate information on gift choice preferences of recipients for the database: choosing a desired gift (assumed) for himself/herself on the same occasion which visitor looks for a gift;

[symbol]

4. The method to generate information on gift choice preferences of recipients for the database: choosing a desired gift (assumed) for himselfherself using Gift Catalog;

[symbol]

5. The method to generate information on gift choice preferences of recipients for the database: choosing a desired gift (assumed) for himself/herself as a prerequisite to get access to the database;

[symbol]

6. The method to generate information on gift choice preferences of recipients for the database: sequences of steps and steps itself to generate information on gift choice preferences of recipients for the database, including: occasion; information about gift recipient; information about website visitor; choosing a desired (assumed) gift for himself/herself from the Gift Catalog: granting access to the database;

[symbol]

7. The set (combination) of characteristics to identify a group of people in order to determine their gift choice preferences: relationship, country of residence (in the USA state also), gender, age group, month of birth, marital status, occupation, level of relationship, hobbies;

[symbol]

8. The method of displaying information on gift choice preferences of recipients from the database based on the Gift Catalog;

[symbol]

9. The method of displaying information on gift choice preferences of recipients extracted from the database as a graph;

[symbol]

10. The method that allows identifying gift choice preferences of recipients by countries (by states in the USA), gender, month of birth, age group, marital status, occupation, level of relationship, hobbies;

[symbol]

11. The Method that allows determining recipient's attitude to an expensive gift;

[symbol]

12. The Method that allows determining expensive gift perception of recipients;

[symbol]

13. The Method that allows determining gift or gift+flowers preferences of recipients;

[symbol]

14. The Gift Catalog, created to determine the gift choices preferences of the visitors and to display gift choice preferences of the recipients.
